(19) United States
(12) Patent Application Publication
(10) Pub. No.: US 2004/0148373 A1
(43) Pub. Date: Jul. 29, 2004

(54) Service level agreement compliance measurement

(75) Inventors: Rhonda L. Childress, Austin, TX (US); Reid Douglas Minyen, Lakeway, TX (US); Neil Raymond Pennell, Austin, TX (US); Thomas M. Ruiz, Universal City, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/351,557

(22) Filed: Jan. 23, 2003

(51) Int. Cl. G06F 15/173

(52) U.S. Cl. 709/223

(57) ABSTRACT

A method, computer program product, and data processing system for attaining measurements to assess the compliance of individual service providers in a complex distributed enterprise computing system is disclosed. The present invention achieves this goal by augmenting a middleware computing environment with a facility for timestamping individual sub-operations at each service provider. In a preferred embodiment, when a message incorporating a transaction is handed off to a service provider, an “in-time” timestamp is generated and appended to the message. When the service provider completes processing of its portion of the transaction, an “out-time” timestamp is generated and appended to the message. When the processing of the transaction is completed, a record of the processing time for each service provider can be found in the message. This information can then be used to verify whether one or more of the service providers are in breach of a service level agreement.

### BACKGROUND OF THE INVENTION

1. Technical Field

The present invention is directed generally toward evaluating whether a given service provider in a distributed enterprise computing system is in compliance with a service level agreement.

2. Description of Related Art

Component-based distributed enterprise computing is an appealing solution to business computing needs. Rather than requiring extensive custom software (and in some cases hardware) to be written to meet the particular enterprise, a component-based distributed enterprise computing model allows different individual applications, services, or other components, possible operating in disparate hardware or software environments, to interoperate. Distributed enterprise computing systems achieve this interoperability through the use of middleware.

Middleware is software that provides a platform for interoperation between software components in a distributed system. Middleware is “middle” for a couple of important reasons. Firstly, middleware allows for communication and interoperation between software components—it operates in between software components (“in the middle”). Secondly, middleware can be thought of as “mid-level” software, somewhere in between low-level operating system software and high-level application software. In other words, middleware provides a platform of computing resources, much like an operating system, but operates as a higher level from an operating system in that middleware provides a model of a distributed computing system as a whole (as opposed to that of a single computer in the distributed system, like what is generally provided in an operating system).

One particularly popular middleware package is Websphere MQ, which is available available from IBM Corporation. A number of standards and application programming interfaces pertaining to middleware exist, including JAVA Messaging Service (JMS), from Sun Microsystems, Inc., NET from Microsoft, Inc., and Common Object Request Broker Architecture (CORBA), which is an open standard from Object Management Group (OMG).

The use of a component-based distributed computing model offers a number of advantages. As was suggested above, it is often easier to combine a number of existing pieces of software together using middleware than it is to write customized software from scratch. This is particularly true in the case of organizations that rely on software systems that have been in place for some time. A distributed system is useful in that some performance increases may be experience through the use of parallel processes. Further, a distributed computing model allows particular subtasks or services to be delegated among different departments or external organizations (service providers).

In order to ensure that transactions in a distributed enterprise computing system are performed in a timely manner, service level agreements may be made between a service provider and an organization utilizing the provider's services. For example, an online retailer that makes use of the services of a shipping company may enter into a service level agreement with the shipping company that states that the shipping company guarantees to respond to a request for a shipping quote within 1.5 seconds of submission.

In a complex enterprise systems, many such service level agreements may be entered into with many service providers. If overall performance of the system is poor, it is necessary to determine which service provider is at fault (i.e., which service provider is in breach of the service level agreement) in order that corrective action may be taken to ensure timely processing of transactions. Current systems measure end-to-end delays (i.e., the total time it takes for a transaction to occur in the overall system). Thus, a need exists for a mechanism to discover individual bottlenecks in a complex distributed enterprise computing system.

### SUMMARY OF THE INVENTION

The present invention provides a method, computer program product, and data processing system for attaining measurements to assess the compliance of individual service providers in a complex distributed enterprise computing system. The present invention achieves this goal by augmenting a middleware computing environment with a facility for timestamping individual sub-operations at each service provider. In a preferred embodiment, when a message incorporating a transaction is handed off to a service provider, an “in-time” timestamp is generated and appended to the message. When the service provider completes processing of its portion of the transaction, an “out-time” timestamp is generated and appended to the message. When the processing of the transaction is completed, a record of the processing time for each service provider can be found in the message. This information can then be used to verify whether one or more of the service providers are in breach of a service level agreement.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a networked data processing system in which the present invention may be implemented;

FIG. 2 is a block diagram of a server system within the networked data processing system of FIG. 1;

FIG. 3 is a block diagram of a client system within the networked data processing system of FIG. 1;

FIG. 4 is a flow diagram of a distributed enterprise computing system in accordance with a preferred embodiment of the present invention;

FIG. 5 is a diagram of a directed acyclic graph representing a process of completing a transaction in a distributed enterprise computing system in accordance with a preferred embodiment of the present invention;

FIG. 6 is a diagram depicting an overall view of a process of performing a transaction in a distributed enterprise computing system in accordance with a preferred embodiment of the present invention;

FIG. 7 is a diagram of a message 700 passed through a middleware environment in accordance with a preferred embodiment of the present invention; and

FIG. 8 is a flowchart representation of a process performing an operation within a transaction in a distributed enterprise computing system in accordance with a preferred embodiment of the present invention.

### DETAILED DESCRIPTION OF THE PREFERRED EMBODIMENT

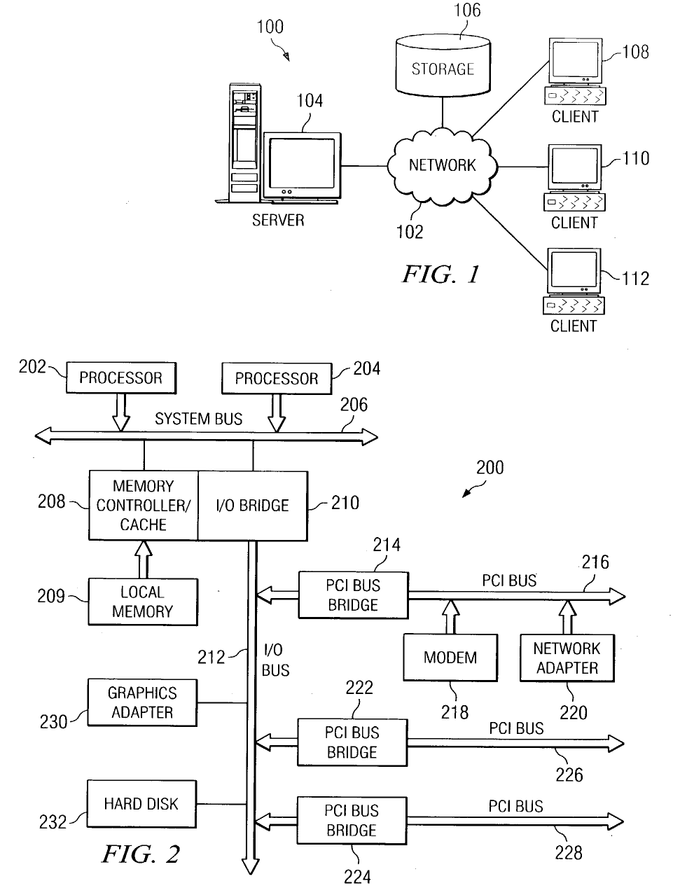

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

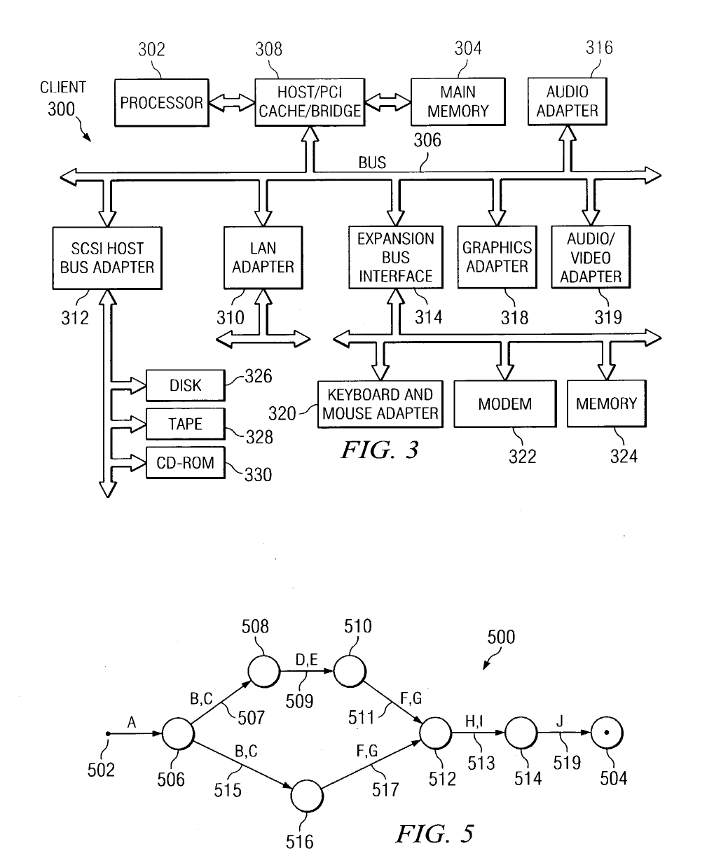

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention is directed toward the acquisition of measurements to judge the whether service providers in a complex distributed enterprise computing system are in compliance with service level agreements. To understand what is meant by this, it is helpful to consider an example of a complex distributed enterprise computing system with a number of service level agreements in place.

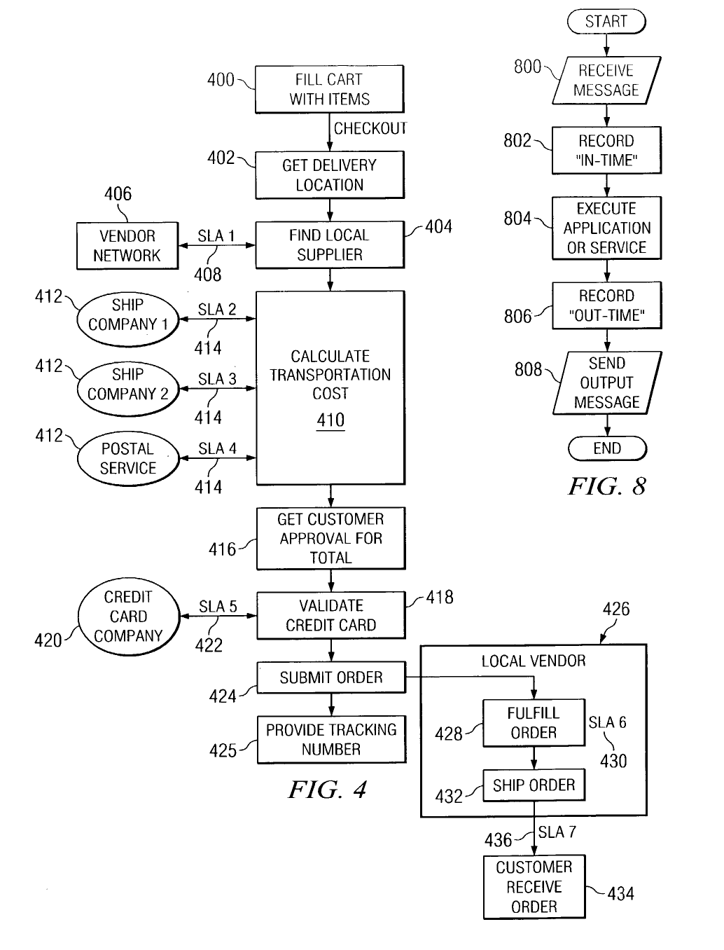

FIG. 4 is a flow-diagram depicting the operation of a distributed enterprise computing system with service level agreements. In particular FIG. 4 is a diagram describing a retail website for mail-ordering products using a familiar “shopping cart” metaphor, which is well known to those skilled in the art. A user shopping the website uses his or her web browser to select items to be purchased, i.e., the user “fills the shopping cart” with items (block 400). The user then enters a shipping address (block 402). The enterprise computing system then initiates a search for a local supplier carrying the desired product(s) (block 404). This is done by querying a network of vendors to determine which vendors have the product(s) and are in proximity to the customer (block 406). Each of the vendors has a service level agreement with the retailer (agreement 408) which specifies that the vendor will reply with an answer within a specified amount of time.

One a vendor is selected (block 404), the shipping cost is then calculated (block 410). Again, this is done by querying computer systems of a number of shipping companies and the postal service (shipping providers 412), each of which has a service level agreement (agreements 414) with the retailer. Customer approval is obtained for the total amount of the purchase (block 416). Then the user's credit card is validated (block 418). This is done by submitting the transaction to a credit card processing company 420, which also has a service level agreement 422 for responding with an authorization or declination.

Next, the order is submitted (block 424) to the select local vendor (vendor 426) and, roughly simultaneously, a tracking number is provided to user to allow the user to check up on the status of the order (block 425). Vendor 426 also has a service level agreement 430 for completing the processing of the order in a specified period of time (e.g., 2 days). Note that this demonstrates that a service level agreement need not be limited to computer processing time, but may also pertain to other operations within the business model of the organization, including transportation time and “human processing time.”

Vendor 426 fills the order (block 426) and then ships the order to the customer (block 432). Again, a service level agreement 436 governs the shipping of the order by the selected shipping provider, so that the customer receives the order (block 434) within a specified time of the order being shipped (block 432). This is another example of a non-computer-processing time constraint on a service provider (in this case, the selected shipping provider).

As can be seen from FIG. 4, a business transaction in a complex system requires many operations from many parts of an enterprise (or outside of the enterprise). It should also be apparent that certain operations depend on the results of previous operations. For example, in FIG. 4 in order to determine the shipping cost, it is necessary to first determine where the order is being shipped to. It is a well-known principle of computer science and operations research that a complete multi-stage transaction (i.e., a transaction that terminates), in which different stages depend on others, may be modeled by a directed acyclic graph (DAG) where the vertices of the graph represent stages of processing and the edges of the graph represent the passing of messages through the middleware environment from stage to stage.

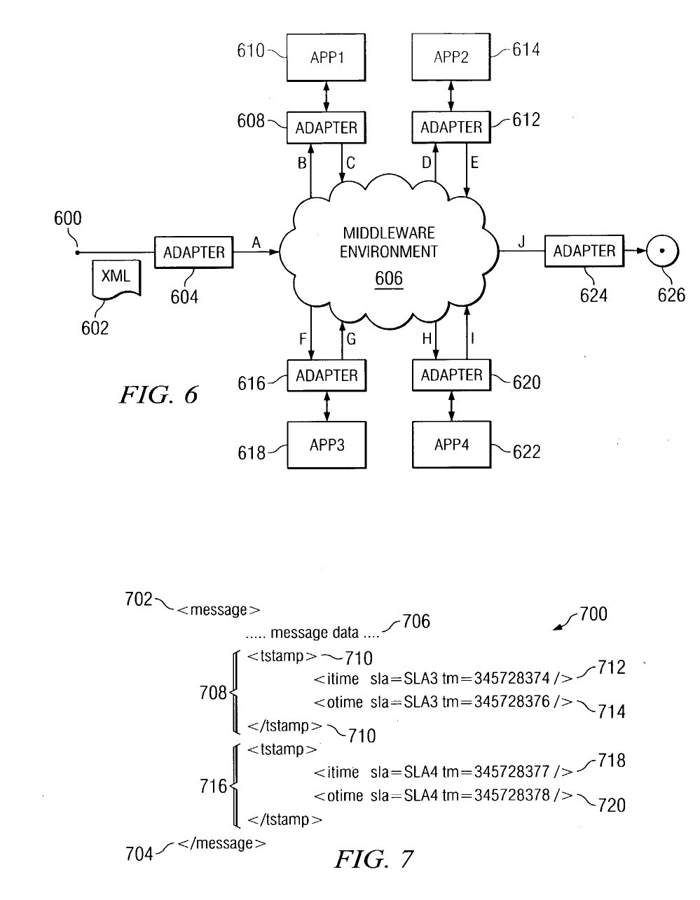

FIG. 5 is a diagram of such a directed acyclic graph. FIG. 5 shows a number of vertices (even-numbered vertices 504-516) representing transmission of a message through middleware and edges (odd numbered edges 507-519) connecting the vertices, representing the transition of each message through service providers from origin 502 of the transaction to completion 504 of the transaction. When read in conjunction with FIG. 6 (q.v.), FIG. 5 shows that each of edges 507-519 (odd) represents a stage in the processing of the transaction. For example, edge 507 represents processing that begins with reception of a message by a service provider (represented by the letter “B” in both FIGS. 5 and 6) and transmission of a message by that service provider (represented by the letter “C” in FIGS. 5 and 6). The details of reception and transmission will be explained in greater detail with respect to FIG. 6.

FIG. 5 shows that a complex distributed enterprise computing system may include operations that occur sequentially and may also include operations that occur concurrently with other operations. This illustrates the complexity of determining which service providers are in breach of their service level agreements. For example, it is difficult to determine whether the service provider associated with vertex 516 is a performance bottleneck or whether either or both of vertex 508 and vertex 510 is a performance bottleneck, since these processes operate concurrently and one or more of the service providers may have no effect on the end-to-end delay.

FIG. 6 is a diagram depicting an overall view of a process of performing a transaction in a distributed enterprise computing system in accordance with a preferred embodiment of the present invention. The transaction begins at origin 600 with the generation of a message containing information defining the transaction. This information may contain instructions, commands, or data that will be used in processing the transaction. In the preferred embodiment depicted in FIG. 6, this message is in the form of an XML (extensible Markup Language) document 602, although other data or command formats may be used without departing from the scope and spirit of the present invention.

Adapter 604 provides a bridge into a middleware environment 606. What is meant by this is that adapter 604 is a software component that provides an interface from whatever software component or application that generated message 602 to middleware environment 606. Middleware environment 606 is simply the distributed environment supported by middleware. In the context of a network, for example, middleware environment 606 is the network, as seen from the perspective of the middleware software. To make an analogy, middleware environment 606 bears the same relationship to the network it is supported on as the World Wide Web bears to the Internet. The World Wide Web is the Internet, but seen from the perspective of a web browser. Similarly, middleware environment 606 is the network or distributed computing platform it runs on, but as seen from the perspective of middleware and accessed using middleware software and its related communications protocols. So, adapter 604 is software that allows message 602 to be transmitted to a service provider over middleware environment 606. Adapters, such as adapter 604, may be routines within an application program or adapters may exist as separate programs or processes

A single stage in the execution of a transaction in a preferred embodiment of the present invention is performed by passing an input message through middleware environment 606 to an adapter, which translates the message into a form that can be read by an application (or service provider). The application then provides output, which is used by the adapter to generate an outgoing message, which is passed to the next stage.

Let us now consider an example from FIG. 6 of the processing of a single stage. Suppose message 602 transmitted by adapter 604 over middleware environment 606 to adapter 608 (this is represented by an arrow labeled “B” in FIG. 6). Adapter 608 can then translate the pertinent contents of message 602 into something that application 610 can understand. Application 610 then executes, based on this translated information. Then application 610 returns output to adapter 608. Adapter 608 generates an outgoing message based on the output of application 610 and the original input message. This message is then transmitted over middleware environment 606 to the next stage of processing (represented by the arrow labeled “C” in FIG. 6). This example of processing a single stage of a transaction corresponds to edge 507 in FIG. 5.

The present invention is directed toward measuring the amount of time spent in each stage of processing a transaction. This is accomplished by appending timestamps to the messages entering and exiting each adapter. In the previous example, when a message is received at adapter 608 (arrow “B”), an “in-time” timestamp of the current time may be recorded, and when the outgoing message is transmitted (arrow “C”), the “in-time” timestamp and an “out-time” timestamp of the current time may be appended to the outgoing message. If each adapter appends timestamps in this fashion in a cumulative manner, the resulting message at the completion of processing will contain information about when and how long each stage of processing took place. This information may be relied upon in order to locate service providers that are either in breach of a service level agreement or that simply happen to be a performance bottleneck.

FIG. 7 is a diagram of a message 700 passed through a middleware environment in accordance with a preferred embodiment of the present invention. Message 700 is depicted as an XML (extensible Markup Language) file, but one of ordinary skill in the art will recognize that any one of a number of formats, both open standards and proprietary standards, may be used in an actual embodiment of the present invention.

Message 700 is encapsulated with “<message>” tags 702, which identify the XML document making up message 700 as a message. Message data 706 describing the transaction and/or its results is enclosed within <message> tags 702. Timestamps 708 and 716 are appended to message 700 at each stage of processing the transaction. Timestamp 708, like timestamp 716, is enclosed within “<tstamp>” tags 710, which denote that the data within <tstamp> tags 710 represents a timestamp.

Each timestamp contains two tags. Timestamp 708 and 716 each contain an “<itime>” tag 712, 718 and an “<otime>” tag 714, 720. <itime> tags 712, 718 represent an “in-time” or the beginning of a stage of processing a transaction. <otime> tags 714, 720 represent an “out-time” or the end of a stage of processing a transaction.

Examining now tags 712 and 714, each of these tags contains a designation of the of the service level agreement associated with timestamp 708 (e.g., “sla=SLA3”) as an attribute. Also, each tag contains a numerical time (e.g., “tm=345728374”), representing the time being recorded by the tag (e.g., in seconds since the beginning of a designated epoch—in many operating systems, this is the number of seconds since Jan. 1, 1970 12:00 AM GMT).

At this point it should be noted that this “in-time”/“out-time” method of recording the processing time associated with a particular operation is only one possible way of recording the time spent in that stage. It is also possible to record the actual number of seconds (or some other unit of time) spent performing the operation, for example. Essentially, any information from which the actual processing time can be derived may be recorded without departing from the scope and spirit of the present invention.

FIG. 8 is a flowchart representation of a process performing an operation within a transaction in a distributed enterprise computing system in accordance with a preferred embodiment of the present invention. A message is received from middleware (block 800). An “in-time” timestamp is appended to the message or otherwise recorded in the message (block 802). The application or service performing the particular operation is executed (block 804). An “out-time” timestamp is appended to the message or otherwise recorded in the outgoing message (block 806), which is then passed onto the next stage of processing through the middleware environment 808.

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method operative in a data processing system, the method comprising:
receiving a message in a distributed computing environment supporting a plurality of application programs;
presenting input to an application program from the plurality of application programs based upon the message;
timestamping an output message with information that indicates time spent by the application program in response to the input;
relaying the timestamped output message through the distributed computing environment for use in presenting input to an additional application program from the plurality of application programs;
timestamping a second output message with information that indicates time spent by the additional application program; and
relaying at least the second output message through the distributed computing environment for use in determining whether any of the plurality of application programs are operating in violation of a service level agreement.

2. The method of claim 1, wherein the information that indicates time spent by the application in response to the input includes an in time and an out time.

3. The method of claim 1, wherein the information that indicates time spent by the application in response to the input includes an explicit amount of time spent by the application program in response to the input.

4. The method of claim 1, further comprising:
adding an identification of the application program to the output message such that the information that indicates time spent by the application program in response to the input is correlated with the identification of the application program.

5. The method of claim 1, wherein the distributed computing environment is distributed over multiple data processing systems.

6. The method of claim 1, further comprising:
generating the output message from the message by modifying the message with output from the application program.

7. The method of claim 1, wherein the message includes prior information indicating time spent by a previously-used application program from the plurality of application programs and the output message is timestamped by including along with the prior information the information that indicates time spent by the application program in response to the input.

8. A computer program product in a computer-readable medium comprising functional descriptive material that, when executed by a computer, enables the computer to perform acts including:
receiving a message in a distributed computing environment supporting a plurality of application programs;
presenting input to an application program from the plurality of application programs based upon the message;
timestamping an output message with information that indicates time spent by the application program in response to the input;
relaying the timestamped output message through the distributed computing environment for use in presenting input to an additional application program from the plurality of application programs;
timestamping a second output message with information that indicates time spent by the additional application program; and
relaying at least the second output message through the distributed computing environment for use in determining whether any of the plurality of application programs are operating in violation of a service level agreement.

9. The computer program product of claim 8, wherein the information that indicates time spent by the application in response to the input includes an in time and an out time.

10. The computer program product of claim 8, wherein the information that indicates time spent by the application in response to the input includes an explicit amount of time spent by the application program in response to the input.

11. The computer program product of claim 8, comprising additional functional descriptive material that, when executed by the computer, enables the computer to perform additional acts including:
adding an identification of the application program to the output message such that the information that indicates time spent by the application program in response to the input is correlated with the identification of the application program.

12. The computer program product of claim 8, wherein the distributed computing environment is distributed over multiple data processing systems.

13. The computer program product of claim 8, comprising additional functional descriptive material that, when executed by the computer, enables the computer to perform additional acts including:
generating the output message from the message by modifying the message with output from the application program.

14. The computer program product of claim 8, wherein the message includes prior information indicating time spent by a previously-used application program from the plurality of application programs and the output message is timestamped by including along with the prior information the information that indicates time spent by the application program in response to the input.

15. A data processing system comprising:
means for receiving a message in a distributed computing environment supporting a plurality of application programs;
means for presenting input to an application program from the plurality of application programs based upon the message;
means for timestamping an output message with information that indicates time spent by the application program in response to the input;
means for relaying the timestamped output message through the distributed computing environment for use in presenting input to an additional application program from the plurality of application programs;
means for timestamping a second output message with information that indicates time spent by the additional application program; and
means for relaying at least the second output message through the distributed computing environment for use in determining whether any of the plurality of application programs are operating in violation of a service level agreement.

16. The data processing system of claim 15, wherein the information that indicates time spent by the application in response to the input includes an in time and an out time.

17. The data processing system of claim 15, wherein the information that indicates time spent by the application in response to the input includes an explicit amount of time spent by the application program in response to the input.

18. The data processing system of claim 15, further comprising:
means for adding an identification of the application program to the output message such that the information that indicates time spent by the application program in response to the input is correlated with the identification of the application program.

19. The data processing system of claim 15, further comprising:
means for generating the output message from the message by modifying the message with output from the application program.

20. The data processing system of claim 15, wherein the message includes prior information indicating time spent by a previously-used application program from the plurality of application programs and the output message is timestamped by including along with the prior information the information that indicates time spent by the application program in response to the input.
